(19) United States
(12) Patent Application Publication
(10) Pub. No.: US 2009/0322953 A1
(43) Pub. Date: Dec. 31, 2009

(54) METHOD AND APPARATUS FOR ACHIEVING SELECTED AUDIO/VIDEO AND OTHER FUNCTIONS

(76) Inventor: Kenneth P. Weiss, Newton, MA (US)

Correspondence Address: LANDO & ANASTASI, LLP, ONE MAIN STREET, SUITE 1100, CAMBRIDGE, MA, 02142, US

(21) Appl. No.: 12/484,777

(22) Filed: Jun. 15, 2009

Related U.S. Application Data
(63) Continuation-in-part of application No. 10/831,879, filed on Apr. 26, 2004.
Application No. 10/831,879 is a division of application No. 09/657,357, filed on Sep. 7, 2000, now abandoned.
(60) Provisional application No. 60/152,837, filed on Sep. 8, 1999.
(60) Provisional application No. 61/152,481, filed on Feb. 13, 2009.

(51) Int. Cl. H04N 9/67

(52) U.S. Cl. 348/660; 348/E05.108; 348/E09.047; 386/124; 386/E09.001

(57) ABSTRACT

A method and apparatus are provided for reproducing an audio, video or data signal. The signal may be a digital input with each segment of the signal being broadcast at least two times, which broadcast transmissions are at time spaced intervals. The time spaced transmissions are stored in at least one RAM, and the multiple transmissions are processed to obtain an enhanced output for each segment, which is applied to a receiver for reproduction. For example, the multiple transmissions for each segment may be compared, and the best transmission for the segment selected as the enhanced output for the segment.

### CROSS-REFERENCE TO RELATED APPLICATIONS

The present application is a continuation-in-part of and claims priority under 35 U.S.C. § 120 to co-pending U.S. patent application Ser. No. 10/831,879 entitled “METHOD AND APPARATUS FOR ACHIEVING SELECTED AUDIO AND OTHER FUNCTIONS” and filed on Apr. 26, 2004, which is a divisional of, and claims priority under 35 U.S.C. § 120 to, U.S. patent application Ser. No. 09/657,357, entitled “METHOD AND APPARATUS FOR ACHIEVING SELECTED AUDIO AND OTHER FUNCTIONS,” filed Sep. 7, 2000, now abandoned, which claims priority under 35 U.S.C. § 119(e) to U.S. Provisional Application No. 60/152,837, filed Sep. 8, 1999. The present application also claims priority under 35 U.S.C. § 119(e) to co-pending U.S. Provisional Application No. 61/152,481 entitled “METHOD AND APPARATUS FOR ACHIEVING SELECTED AUDIO/VIDEO AND OTHER FUNCTIONS” and filed on Feb. 13, 2009. Each of the above-identified applications is herein incorporated by reference in its entirety.

### BACKGROUND

1. Field of the Invention

This invention relates to the fields of audio and/or video receipt and reproduction, and of digital transmission. More particularly, it relates to a method and apparatus for permitting a selected interval of a received signal to be digitally stored and to be replayed on demand in selected ways and to techniques for enhanced reception of digital transmissions.

2. Discussion of Related Art

There are numerous situations when one is listening to a radio broadcast, to a recorded message received on a telephone or in other situations where an audio signal is being received at an audio receive and reproduction device, where a user may either miss a piece of information they wanted to hear, and wish to hear that piece of information again, or where the user particularly enjoyed a recently received input, for example a piece of music or the sound of a loved one's voice, and would like to hear it again. Further, there are times when information is received on a radio, telephone or the like, which a listener would like to write down for future reference, for example an address or telephone number, the name and/or composer of a piece of music being played or the like, but where, either because the listener is driving or is otherwise not in a position to write information down at the time it is reproduced, or because the listener does not have a writing implement and paper handy at the time the information is broadcast, the information is lost.

In such and similar situations, it would be desirable if an audio repeat feature were available which would permit either instant replay of the desired audio input and/or permit storage of the desired interval of material for replay at a subsequent time when the user is in a position to write required information down or otherwise utilize the reproduced information. However, if a portion of received information were replayed, this would normally result in a corresponding portion of the received information being lost. A simple, reliable, integrated, user friendly method and apparatus does not currently exist which permits the replay of a desired interval of a received audio without loss of desired incoming material and/or which permits storage of a selected interval of received audio for listening at a later time, which time is solely at the discretion of the user. A need therefore exists for a method and/or apparatus for facilitating such capability.

There are a number of related problems in audio receive and reproduction devices, for which adequate solutions do not currently exist. First, commercials on most radio stations are becoming longer and louder, and there are frequently other parts of a radio broadcast or other received audio which one does not want to listen to, but is forced to listen to in order to receive desired audio. A need exists for a simple way to permit a listener to get rid of such undesired audio without missing the audio that the listener wishes to hear.

There are also times when a listener, while not wanting to avoid a received audio, would like to scan through some such material more quickly. Similarly, there are times when a listener may have trouble understanding what is being said on an audio and would like to slow down the received audio so as to be able to understand it better. Such a capability of either speeding up or slowing down a received audio, particularly by user controlled amounts, does not exist in standard, relatively inexpensive products and a need therefore exists for providing this capability in a reliable, yet simple and inexpensive way.

Finally, there are times when a received audio, particularly from a rural station, is distorted by static or other noise or where audio signal may even be temporally lost. This may be particularly true where the audio receiver is a car radio, a portable radio or the like, where the orientation of the radio antenna may vary with time and/or where the radio may temporarily be in a tunnel, building or the like, where quality of received audio is downgraded. Again, a simple technique for dealing with such problems does not currently exist, which technique is completely transparent to the user. Similar problems can also arise in other transmissions, particularly digital transmission of audio, video, data and/or the like.

### SUMMARY OF THE INVENTION

In accordance with the above, aspects and embodiments of this invention provide a repeat method and apparatus for use with an audio and/or video receive and reproduce device, such as a television, radio or telephone. In one example of an audio and/or video receive and reproduce device, the apparatus includes a random access memory (RAM) connected to normally receive and store audio/video inputs applied to the device, a manually operable input component, and a control operable in response to a selected input from the component for inhibiting application of incoming audio/video inputs to the device and for instead applying audio/video inputs stored in the RAM as audio/video inputs to the device. When the device is receiving inputs from the RAM, the circuit is in a replay mode, the audio/video reproduced by the device when in replay mode being selectively delayed from incoming audio/video inputs by a time interval that is dependent on where in the RAM the control begins applying the audio/video inputs to the device. The location in RAM, and thus the delay between incoming audio/video inputs and reproduction is preferably controllable in response to selective operation of the manually operable component. Such delay may, for example, be a function of the number of times the component is operated, or the time duration for which the component is operated. Depending upon the nature of the component, it may also be a function of the number of degrees the component is turned.

The circuit may also include an output element providing a selected indication that the circuit is in replay mode, and may also provide an indication as to the extent of delay. The output element is preferably a selected display such as a light emitting diode (LED). The control may cause such display to blink at a rate which is a function of the delay. The display may also be in a different state, for example a different color, when the circuit is in replay and normal mode. For a preferred embodiment, the display is a multicolor LED, the circuit displaying one color for replay mode and selected different color for normal mode.

The RAM is preferably a wrap-around memory, the oldest audio input therein being written over when a new audio/video input is received and the RAM is full. The control may inhibit writing over of audio/video inputs into the RAM in response to a selected input from the input component, the circuit being in storage mode when this occurs. Audio/video inputs are applied to the device when the circuit is in storage mode. The LED may also display a third color when the circuit is in storage mode, or some other output may be provided for this indication. When the circuit is in storage mode, the control may be operative in response to a selected input from the input component to cause at least selected portions of audio/video inputs stored in the RAM to be reproduced on the device, the selected input for example being manual operation of the input component for a selected time interval.

Where the device is a radio, the circuit may be returned from replay mode to normal mode when select changes are made on the radio, such as changing the station or turning the radio off. The device may also include an analog-to-digital (A/D) converter between incoming audio inputs and the RAM and a digital to analog (D/A) converter between the RAM and the device. The control may also perform selected control functions on audio input to the RAM including, but not limited to compression.

The input component may also be operable to indicate a desired rate at which audio/video inputs are to be reproduced at the device and the control may be operable in response to a rate indication from the input component for controlling the rate at which the RAM is read out to apply audio/video inputs to the device. The component may be operable in at least two different ways, for example being pressable, turnable, and/or movable from side to side, the input component being operated in a select way to indicate a desired rate for RAM readout, and thus for audio reproduction at the device.

The control may also be operative in response to a selected input to set the circuit into an elimination mode. When in elimination mode, the control may be operative to store in the RAM a selected duration of audio/video inputs ahead of inputs received by the RAM, and may be responsive, when in elimination mode, to a selected input from the input component for skipping an audio/video duration in the RAM which is less than the selected duration, whereby audio/video during such skipped audio/video duration is not reproduced at the device. The skipped audio/video duration may be variable in response to variations in a selected input from the input component. The control may also be operative when in elimination mode to store a selected duration in the RAM before applying audio/video inputs from the RAM to the device. Alternatively, the control may be operative when in elimination mode to apply audio/video inputs to the device from the RAM. The RAM in this case may be read out to apply inputs to the device, at any time the RAM is not storing at least the selected duration of audio/video inputs, at a slower rate than audio/video inputs are received to be stored in the RAM.

The audio and/or video inputs may also be digital inputs, with each segment of digital input being transmitted during at least two time-spaced intervals. The time space transmissions are stored in the RAM. The controller then reads out all stored transmissions for a given audio input and, processes, modifies and/or corrects the multiple transmissions to obtain an enhanced audio input for the device. For example, the controller can compare the multiple transmissions and select the best transmission for each audio input section as the enhanced audio input to be applied to the device for the segment. A similar technique may be employed to enhance digital video, data or other transmissions. These techniques may be useful, for example, when a received audio/video transmission or time-spaced transmissions, is distorted by static or other noise, for example, where the receiver is a satellite radio or digital television receiver and the location of the vehicle and the orientation of the receiver antenna may vary with time and/or where the vehicle signal may temporarily be in a tunnel, building or the like, and where quality of received audio and/or video is downgraded or even lost. By using multiple transmissions of the signal, the controller may be able to compensate for such a downgraded or lost signal and provide an enhanced or composite signal that comprises the best quality or entire signal to the device.

Embodiments of the invention also include a method for providing enhanced audio, video, data or other outputs which includes digitally transmitting each segment of a broadcast thereof at least two times, the broadcast transmissions being at time-spaced intervals, storing the time-spaced transmissions in at least one RAM, reading out all stored transmissions for each broadcast segment, processing the multiple transmissions to obtain an enhanced output for the segment, and applying the enhanced output for utilization, for example to be reproduced by a radio or television receiver. The processing step may for example, include, comparing the multiple transmissions for each segment, and selecting the best transmission for the segment as the enhanced output for the segment. As discussed above, this can be used to compensate for a downgraded signal quality or even a lost signal.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

FIG. 1 is a schematic block diagram of one example of a circuit including an audio/video receiving and reproduction device according to aspects of the invention;

FIG. 2 is a block diagram of one example of a method for practicing the teachings of this invention in accordance with a preferred embodiment;

FIG. 3 is a table indicating button operation and illuminations for an illustrative embodiment; and

FIG. 4 is a schematic block diagram of a circuit suitable for practicing an alternative embodiment of the invention.

### DETAILED DESCRIPTION

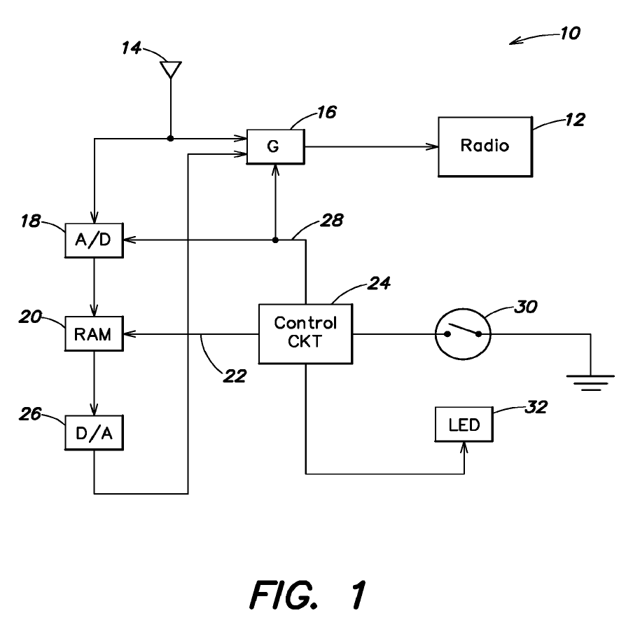

Referring to FIG. 1, there is illustrated one embodiment of a circuit 10 that includes an audio receiving and reproduction device 12 which is shown in FIG. 1 as being a radio. Radio 12 receives inputs from an antenna 14 through a gate 16. These inputs may be, for example, targeted or broadcast signals from one or more satellite or terrestrial sources. The audio output from antenna 14 is also applied through an analog-to-digital (A/D) converter 18 to a random access memory (RAM) 20 where the received information is stored at an address determined by an address input on line 22 from a control circuit 24. Outputs from RAM 20, which outputs are generated in response to signals on line 22 from control circuit 24, pass through digital-to-analog (D/A) converter 26 to a second input of gate 16. The input to gate 16 which is passed to radio 12 is determined by a control input on line 28 from control circuit 24. The control signals on line 28 may also be applied to enable/disable A/D converter 18. Control circuit 24 receives inputs from a switch or button 30 which is selectively operated manually by a user of circuit 10. Switch 30 for the illustrative embodiment is a normally open switch which remains closed only when being pressed or otherwise operated by a user. A display device 32, which is indicated in FIG. 1 as a light-emitting diode (LED), is operated by control 24 to indicate the current state of circuit 10. According to one embodiment, LED 32 is a multi-color LED and is positioned within a button on or adjacent to the controls for radio 12, the color displayed at this button being indicative, as discussed hereinafter, of the state of the circuit. The button containing LED 32 may be preferably also used to control switch 30. Control circuit 24 may be a microprocessor, signal processor or other general purpose processor chip programmed to perform control functions in accordance with the embodiments of this invention, may be a special purpose circuit designed to perform such control functions or may be a hybrid of hardware and software designed to perform the requisite control functions. Control circuit 24 may also be partially or fully automatic so that no user input is required, for example, to automatically process the signal at the inputs to the gate and select between them.

It is to be appreciated that although the illustrated receiver is an analog radio 12, the invention is not limited to analog radios receiving analog audio signals; for example, the receiver may be a digital satellite radio that receives at least one or time-spaced digital broadcast signals and that stores and processes the received digital signal(s) according to this disclosure. The device 12 may also be a digital television and/or video recorder that receives at least one or time-spaced digital broadcast signals and that stores and processes the received digital signal(s) according to this disclosure. The device 12 may also be another device such as a personal computer, firewall or router, that receives digital data over the Internet, or another receiving device. Accordingly, although the following discussion may refer primarily to audio signals it is to be appreciated that the apparatuses may also receive and process video and/or data signals.

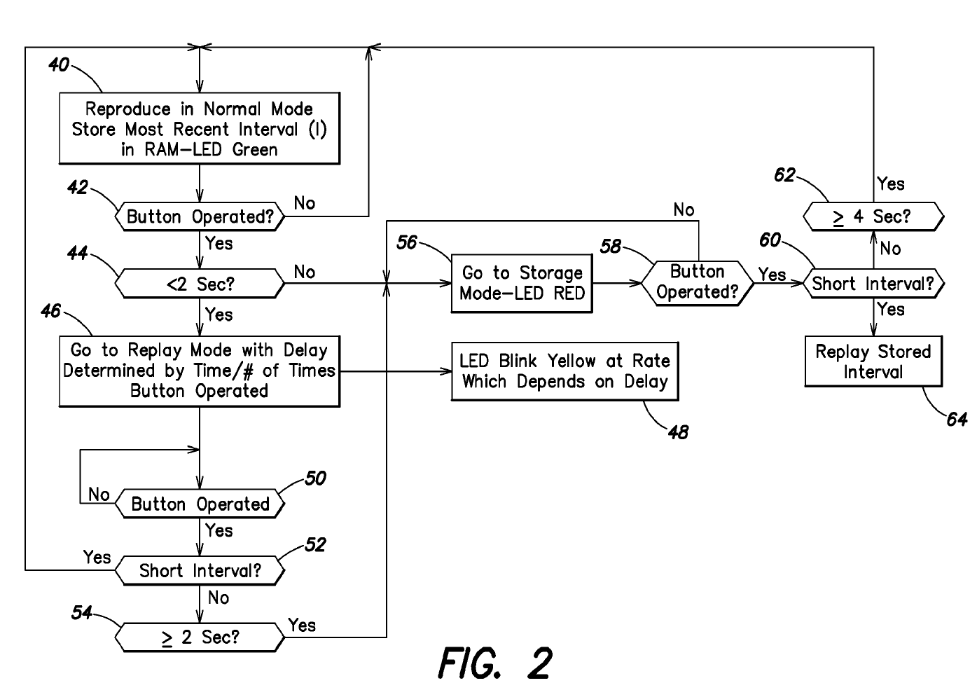

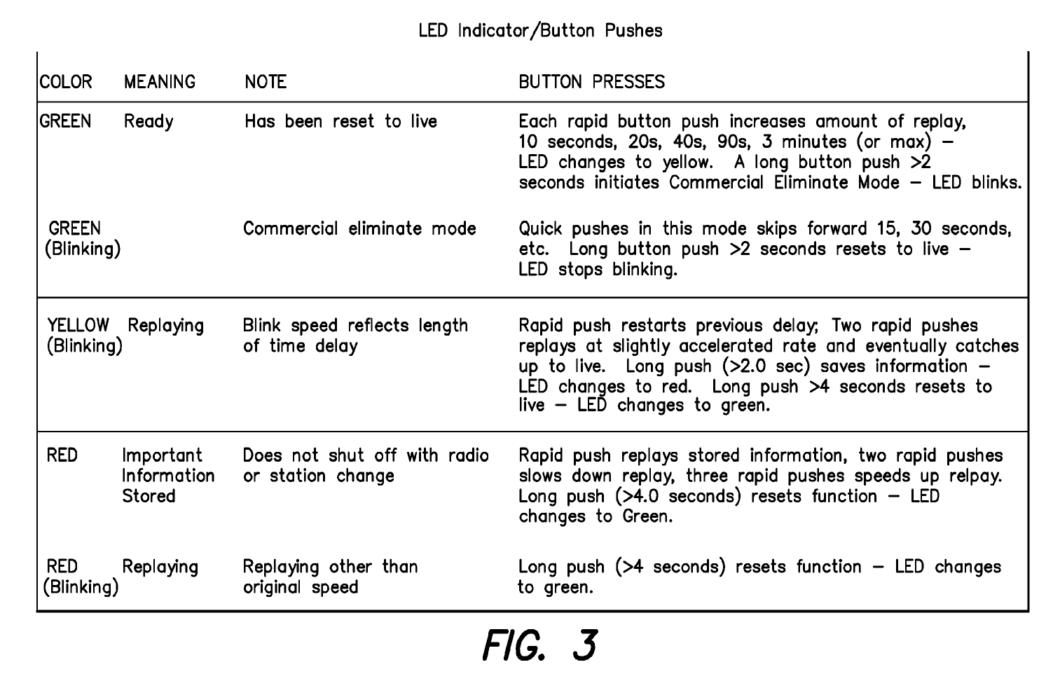

Referring to FIG. 2, it is seen that circuit 10 is initially in a “normal mode” wherein gate 16 passes audio (or video or data) inputs from antenna 14 to be reproduced by device 12 and simultaneously passes such audio inputs through A/D converter 18 to be stored in RAM 20. RAM 20 is operated as a “wrap-around” memory so that once RAM 20 has been filled, the next audio input in digital form is written over the oldest audio input stored in the memory. Control circuit 24 keeps track of the address in RAM 20 storing the oldest audio input at any point in time. Thus, RAM 20 stores the most recent interval (I) of audio input being received. The duration of interval (I) will depend on the size of RAM 20 and the rate of transmission of the signal, which is in turn determined by the maximum interval of received audio which it is desired to reproduce. Such interval might range from tens of seconds, for example 20 or 30 seconds, to several minutes, for example 3 to 5 minutes, although longer intervals are also possible. In some instance, the more memory which is provided in RAM 20, the more expensive circuit 10 becomes. Shorter intervals for memory 20 may be appropriate where it was only desired to reproduce a short interval of missed information, for example a weather report, telephone number, address, the name of a piece of music, the performer on a piece of music, or the like. The longer time intervals would be required where, for example, it was desired to replay a piece of music which was just heard or the like. For example, where the data rate of an incoming radio signal from a satellite, or other source, is temporally slower than the normally desired playback speed for the encoded data, the RAM 20 may act as a buffer, storing a portion of the signal such that a listener can reproduce the received data at an acceptable rate without experiencing breaks in the program. In such an example, it may be desirable for RAM 20 to have a sufficient size to compensate for the slower data rate from the source for a sufficient time period. As another example, the RAM may act as a buffer where data is being streamed over the Internet at, for example, a slow or inconsistent data rate. RAM 20 would be of sufficient quality to provide good audio reproduction, as would be converters 18 and 26. Finally, when circuit 10 is in normal mode as indicated by block 40, LED 32, which is preferably a multi-color LED, is illuminated in a selected color, which color is indicated as green for the illustrative embodiment. This is also indicated on line 1 of the FIG. 3 table, the table indicating LED color for each mode and available button operations for the mode.

As circuit 10 is operating in normal mode, control circuit 24 is monitoring button 30 to determine if it is operated (step 42). So long as button 30 is not operated, circuit 10 remains in the normal mode. However, when control circuit 24 determines that button 30 has been operated, it proceeds to step 44 to determine the duration of operation for button 30, and in particular to determine if the button is operated for a period of less than 2 seconds for an illustrative embodiment. If during step 44 it is determined that the button or switch 30 has been operated for less than 2 seconds, then the operation proceeds to step 46, causing circuit 10 to enter replay mode.

While the duration of the interval being replayed can be fixed, it can also be variable and automatically determined by the control circuit 24, and can also be, controllable based on the operation of button/switch 30. Further, while the duration may be controlled in response to the time interval during which button 30 is operated, it is also considered for such interval to be determined by the number of times button 30 is operated. Thus, a single rapid operation of the button may result in a 10 second delay, two rapid operations in a 20 second delay, three rapid operations in a 40 second delay and four rapid operations in a delay equal to the maximum interval storable in RAM 20. Control circuit 24 may control LED 32 so as to change color, for example to the color yellow, when circuit 10 goes into replay mode, and to cause this display to blink or flash at a rate which depends on the replay interval (step 48/line 2 of FIG. 3). Controller 24 thus has the ability to enter RAM 20 at an address therein spaced from the address where current inputs are being stored by an interval equal to the desired replay interval and to read out data through converter 26 and gate 16, which is now enabled by a signal on line 28 to pass inputs from converter 26 rather than from antenna 14, to control what is being reproduced on radio 12. Radio 12 thus starts reproducing audio with a time delay from currently received audio. However, since currently received audio is still being passed through converter 18 and stored in RAM 20, this delayed output can continue indefinitely for so long as the user wishes, thus assuring that desired input is not missed. In another example, controller 24 can be adapted to remove “gaps” in a received signal by storing incoming data streams at sequential locations in RAM 20.

While the delayed audio is being reproduced, control circuit 24 continues to monitor button 30 (step 50) to determine if it is being operated. If button 30 is not operated, circuit 10 remains in replay mode. If button 30 is operated for a short interval (step 52), control circuit 24 recognizes this as an indication that the user wishes to exit replay mode and return to normal mode. The user may for example operate button 30 during a commercial or other place in the audio input where they do not mind missing part of the received input. Thus, when a depression of button 30 for a short interval is detected during step 52, control circuit 24 causes the circuit to return to normal mode, gate 16 being enabled to pass audio inputs from antenna 14 directly to radio 12 and LED 32 being illuminated in its normal mode or green display.

However, if instead of button 30 being operated for a short interval when circuit 10 is in replay mode, the button is detected as being operated for two or more seconds (step 52), this means that the user wants to store something in the prior received interval for future replay at a more convenient time when, for example, some portion of the stored information may be written down. Thus, when a “yes” output is received from step 54, or a “no” output is obtained during step 44, control circuit 24 goes to step 56 to transfer circuit 10 into storage mode. When in storage mode, control circuit 24 generates outputs on lines 28 to enable gate 16 to pass audio inputs directly from antenna 14 to radio 12 and to disable A/D converter 18 so that inputs are no longer applied to RAM 20 and the LED is illuminate with a different color (for example, red) (line 3 of FIG. 3). Alternatively, control circuit 24 may stop applying “write” inputs to RAM 20 rather than disabling A/D converter 18. In either event, what is in RAM 20 at the time button 30 is operated for the two second interval remains in the RAM rather than being overwritten be newly received audio inputs.

Circuit 10 remains in storage mode, with the control circuit monitoring button 30 (step 58) until an operation of the button is detected. When such operation is detected, control circuit 24 determines if such operation is for a short interval (step 60) or for an interval equal to or greater than for example 4 seconds (step 62). If the button is operated for a short interval, the operation proceeds to step 64 to cause the stored interval in RAM 20 to be read out through D/A converter 26 and through gate 16, which is enabled to pass outputs from converter 26 to radio 12, to cause the desired interval to be reproduced on the radio. Since circuit 10 is still in store mode, such reproduction or replay of the stored interval may be repeated if necessary until the user is satisfied.

Once the user is finished with the stored interval, the user may operate button 30 for a longer time interval, for example an interval equal to or greater than four seconds. When such a long operation of button 30 is detected during step 62, this causes circuit 10 to return to normal mode, with inputs from antenna 14 being applied both through gate 16 to radio 12 and through the A/D converter to be stored in RAM 20, and with LED 32 in its normal or green display.

While in the discussion above, conversion from replay mode to normal mode is in response to a suitable operation of button 30, exiting replay mode may also occur in response to other inputs. For example, where device 12 is a radio as shown in FIG. 1, control circuit 24 could also monitor operation of radio 12 and could cause circuit 10 to return to normal mode in response to selected operations of the radio controls, such as changing station and/or turning the radio off. Where the device 12 was for example a telephone, returning to normal mode might occur in response to the telephone receiver being returned to its cradle.

Further, while in the Figures, the output from A/D converter 18 is shown as being applied directly to RAM 20, the output from the A/D converter could be applied either through control circuit 24 or through a suitable processing circuit under control of circuit 24, to compress or otherwise process the received audio signal in digital form before applying it to RAM 20. Such processing could for example enhance the audio/video quality of the output and/or significantly reduce the amount of storage 20 required to store a selected interval of audio to be replayed.

While in the discussion above, it has been assumed that once the circuit enters replay mode, it remains in replay mode until the user operates a switch or button 30 in suitable manner to return the circuit to normal mode, or device/radio 12 is operated in a way to cause the circuit to return to normal mode, these are not limitations on the invention. For example, when in replay mode, RAM 20 could be read out by controls 24 at a rate slightly higher than the rate at which audio inputs are being received from antenna 14, this rate being sufficiently slow, so that the slight increase in rate of audio output would not be detectable or objectionable to the user. This would result in the delay interval slowly disappearing, the circuit returning to normal mode when currently received audio is being read out of the RAM.

The user may also be provided with the ability to control the rate at which RAM 20 is being read out when in replay mode. For example, two rapid pushes on button 30 may cause a slight speedup in replay so as to permit the user to more rapidly receive desired information and three rapid pushes may cause the replay to slow down, making it easier for the user to understand something being said that the user could not previously understand. This function could also be facilitated by providing a control which could be operated in multiple ways, for example, being both pushable in the manner indicated above, and also turnable and/or movable from side to side to adjust a rheostat or other control, which in turn controls readout rate from the RAM.

Circuit 10 might also be used to provide the user with the ability to eliminate commercials or other undesired received audio with minimal if any affect on desired audio. This could be accomplished by operating the button, for a long interval, for example two seconds or greater, when the radio is first turned on or at any other time when the radio is in normal mode. This will cause the circuit to go into and elimination mode (line 4 of FIG. 3) during which the display will again take on a different appearance, for example a blinking green. When in elimination mode, if RAM 20 is empty, as when the radio is first turned on, reproduction on the radio is delayed for a period of time sufficient to fill RAM 20, reproduction from radio 12 then beginning from RAM 20 with maximum delay available. If one goes into elimination mode when RAM 20 is full (i.e. from normal mode), operation switches to production from RAM 20 with maximum delay. Audio in RAM 20 when this is done may be replayed or blanked. Alternatively, when elimination mode is initiated, RAM 20 can be read out to cause audio output from radio 12 at a slower rate than input is being received from antenna 14 until RAM 20 is full, so that no time is lost entering this mode or audio output already heard is not replayed. In either event, once in elimination mode, a quick push on button 30 may cause control circuit 24 to skip over a selected segment of material stored in RAM 20, for example 15 to 30 seconds of such material, so as to eliminate a commercial or other undesired material, much as one fast forwards on playing back a program on a VCR. The skip forward may for example be, in 15 second intervals for each press of the button, so that the user can control the step-forward interval. Alternatively, a dial should be provided on a multifunction control of the type previously discussed, permitting the user to scan ahead to the end of the undesired material. A long press on button 30, again for example an interval of two seconds or greater, could be utilized to restore the circuit to the normal mode.

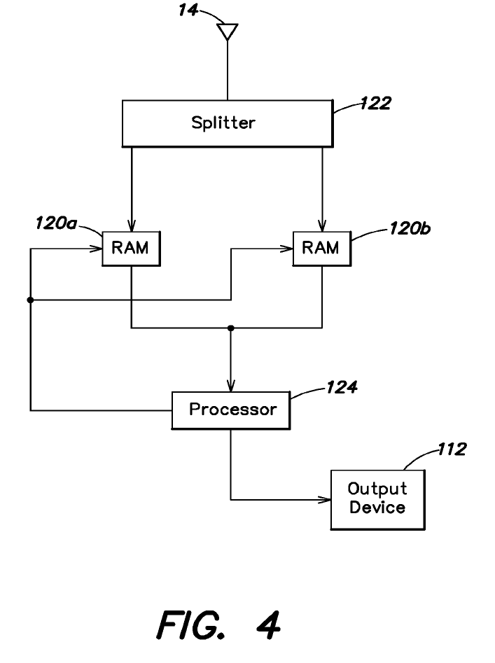

FIG. 4 illustrates an alternative embodiment of the invention wherein, in order to enhance the quality of audio/video reproduction, audio/video signals being transmitted are assumed to be digitally transmitted, and each segment of such digital transmission could be transmitted twice or more, with the transmissions being spaced by a selected time interval. For purposes of FIG. 4, it is assumed that each segment of the transmission is transmitted twice, and that each segment is of a selected duration which may be translated into a selected number of bytes in a corresponding RAM. It is further assumed that either the segments can be time multiplexed or that there is something in each transmission segment identifying the end of a segment, for example a selected bit combination or byte; alternatively, rather than having an end of segment byte, a beginning of segment byte could be provided which also identifies the segment transmission for the given segment.

Digital broadcast transmissions, such as satellite radio or broadcast television transmissions, are subject to federal regulations and stringent bandwidth restrictions. Prior to Applicant's invention, conventional wisdom suggested that service providers should supply as large a number of programming choices to customers, as possible. Therefore, efficient use of bandwidth was key to, for example, existing satellite television, and satellite radio broadcast systems. In particular, under conventional wisdom it was considered preferable to efficiently manage the limited available bandwidth to allow service providers to offer the greatest variety of service such as, for example, a large number of different satellite radio/television channels.

By contrast, according to one embodiment of the invention as discussed above, each segment of a single digital transmission, such as a satellite radio signal or digital television signal, is transmitted at least twice or more times, with the transmissions being spaced by a selected time interval. Prior to Applicant's invention, transmitting each segment of a single digital signal at two time-spaced intervals would have effectively reduced the bandwidth available for transmitting other signals, and therefore would have been seen as undesirable under conventional thinking. In addition, in conventional approaches, providing a wide range of programming was the primary goal, and was more important than preventing short-term signal loss. Thus, prior to Applicant's invention, there would have been no motivation to sacrifice channels offered by service providers by reducing available signal bandwidth so as to be able to transmit each signal segment in at least two time-spaced intervals. However, contrary to conventional thinking, the Applicant has recognized that transmitting each signal segment in at two time-spaced intervals and processing the multiple signals provides significant benefits, including, for example, providing for processing the multiple signals to provide enhanced signal quality, providing for processing the multiple signals to reduce or prevent short term signal loss, and providing for additional capacity for transmitting, receiving, and providing the same signal. For example, the additional capacity may include transmitting and receiving variants of the same signal such as in different languages.

According to one embodiment, while successive segments received through antenna 14 may be stored in successive locations in the same RAM, for purposes of accessing, it may be easier if the time spaced segments are stored either in separate RAMs 120a, 120b or in separate areas of the same RAM. A splitter 122 may be provided which receives the inputs, performs any required preprocessing on such inputs, and directs the inputs to the appropriate RAM 120 or to the appropriate portion of a RAM.

When a given segment is to be reproduced, the corresponding segments from both transmissions are read out to processor 124. Processor 124 then processes the two received segments in a suitable way to provide an enhanced audio/video output to an output device 112, which for an illustrative embodiment would be a radio, such as a digital satellite radio, or a television or video receiver/recorder that receives audio and/or video signals from one or more satellite and/or terrestrial, and/or other sources. In the simplest case, the two transmissions are compared and the better segment, the one containing, for example the least noise or static or the one containing the signal as compared to the one in which the signal is lost, and/or the one having the highest amplitude or signal-to-noise ratio, would be sent to output device 112. It is to be appreciated that more sophisticated processing algorithms are also possible. As has already been discussed herein, the embodiment of FIG. 4 can enhance received radio transmissions, be utilized with other digital broadcasts or transmissions such as digital video or data transmissions, for example in a switch, router, firewall or PC of a personal computer, with each such broadcast being transmitted at least twice at spaced intervals, stored, and the two transmissions for a given segment being read out and processed to obtain the enhanced broadcast.

Thus, while the invention has been particularly shown and described above with reference to preferred or illustrative embodiments, the foregoing and other changes in form and detail may be made therein by one skilled in the art without departing from the spirit and scope of the invention which is to be defined only by the appended claims.

What is claimed is:

1. A digital video receiver including:
an input for receiving digital video signals;
a RAM adapted to receive the digital video signals from the input and to store the digital video signals;
a controller operable to read the digital video signals from RAM, to process the digital video inputs stored in said RAM to provide an enhanced form of the digital video signals to said digital video receiver;
wherein each digital video signal comprises at least a first segment and a second segment, the first segment of each digital video signal being transmitted during at least two time-spaced intervals and the second segment of each digital video signal being transmitted during at least two time-spaced intervals, said time-spaced transmissions being received at said input and stored in said RAM; and
wherein said controller reads out the stored transmissions and processes the stored transmissions to obtain the enhanced video input for applying to said digital video receiver.

2. The digital video receiver as claimed in claim 1, wherein said controller is adapted to compare said time-spaced transmissions and select a best transmission for each video input segment as the enhanced video input applied to said digital video receiver for the segment.

3. The digital video receiver as claimed in claim 1, wherein said time-spaced transmissions include multiple versions of a same digital signal.

4. The digital video receiver as claimed in claim 1, wherein the digital video signals are digital audio-video signals.

5. The digital video receiver as claimed in claim 1, wherein the digital video signals are transmitted by a terrestrial television broadcast system.

6. The digital video receiver as claimed in claim 1, wherein the digital video signals are transmitted by a satellite television system.

7. A method for providing a digital video signal including:
digitally transmitting a segment of the digital video signal at least two times, which broadcast transmissions of the segment are at time-spaced intervals;
storing said time-spaced transmissions;
processing the stored transmissions to obtain an enhanced video for the segment; and
applying the enhanced video to a digital video receiver.

8. The method as claimed in claim 7, wherein said processing step includes comparing said multiple transmissions for each segment, and selecting the best transmission for the segment as the enhanced video for the segment.

9. The method as claimed in claim 7, wherein transmitting the segment of the digital video signal at least two times includes transmitting at least two versions of the segment of the digital video signal.

10. The method as claimed in claim 7, wherein digitally transmitting the segment of the digital video signal includes digitally transmitting the segment from a terrestrial television broadcast system.

11. The method as claimed in claim 7, wherein digitally transmitting the segment of the digital video signal includes digitally transmitting the segment from a satellite television broadcast system.

12. A method for providing enhanced digital audio-video, including:
digitally transmitting every segment of a digital audio-video signal at least twice, at time-spaced intervals, to provide time-spaced digital transmissions;
storing said time-spaced digital transmissions to provide stored time-spaced digital transmissions;
processing the stored time-spaced digital transmissions by at least removing any gaps from the stored time-spaced digital transmissions to obtain an enhanced output for each segment; and
applying the enhanced output to an audio/video receiver for utilization.

13. The method as claimed in claim 12, wherein said processing step further includes comparing said multiple time-spaced digital transmissions for each segment, and selecting the best transmission for the segment as the enhanced output for the segment.

14. The method as claimed in claim 12, wherein digitally transmitting every segment of the digital audio-video signal at least twice includes digitally transmitting multiple versions of every segment of the digital audio-video signal.

15. The method as claimed in claim 12, wherein digitally transmitting every segment of the digital audio-video signal includes digitally transmitting the digital audio-video signal from a terrestrial television broadcast system.

16. The method as claimed in claim 12, wherein digitally transmitting every segment of the digital audio-video signal includes digitally transmitting the digital audio-video signal from a satellite television broadcast system.

17. An apparatus for providing an enhanced audio-video signal, comprising:
a digital audio-video receiver configured to receive at least two time-spaced versions of a digital audio-video signal;
a RAM coupled to the digital audio-video receiver and adapted to store the at least two time-spaced versions of the digital audio-video signal;
a controller adapted to process the at least two time-spaced versions of the digital audio-video signal by at least removing any gaps from the at least two time-spaced versions of the digital audio-video transmission to obtain the enhanced output signal.

18. The apparatus as claimed in claim 18, wherein the controller is further adapted to compare the at least two time-spaced versions of the digital audio-video signal and select a first one of the time-spaced versions having better signal characteristics than a second one of the time-spaced versions.

19. The apparatus as claimed in claim 17, wherein the at least two time-spaced versions of the digital audio-video signal includes multiple versions of the digital audio-video signal.

20. The apparatus as claimed in claim 17, wherein the digital audio-video receiver is a digital television.

21. A system for reception and playback of a digital video signal, comprising:
a video receiver that is adapted to receive at least two time-spaced digital transmissions of a same digital video signal;
a RAM coupled to the receiver and adapted to store the at least two time-spaced digital transmissions; and
a controller, coupled to the RAM and to the receiver, that is adapted to read out the stored at least two time-spaced digital transmissions from the RAM and to process the received at least two time-spaced digital transmissions by at least removing any gaps from the at least two time-spaced digital transmissions to provide the digital video signal having enhanced video properties, and to apply the digital video signal having enhanced properties for playback by the video receiver.

22. The system as claimed in claim 21, wherein the video receiver is a satellite video receiver.

23. The system as claimed in claim 21, wherein the video receiver is a terrestrial broadcast television receiver.
